(19) United States
(12) Patent Application Publication
(10) Pub. No.: US 2012/0182653 A1
(43) Pub. Date: Jul. 19, 2012

(54) SEMICONDUCTOR MODULE AND SYSTEM INCLUDING THE SAME

(75) Inventors: Joo-Han LEE, Asan-si (KR); Young-Soo AN, Yongin-si (KR); Yong-Hyun KIM, Yongin-si (KR); Seong-Chan HAN, Cheonan-si (KR)

(73) Assignee: SAMSUNG ELECTRONICS CO., LTD., Suwon-si (KR)

(21) Appl. No.: 13/316,020

(22) Filed: Dec. 9, 2011

(30) Foreign Application Priority Data
Jan. 18, 2011 (KR) 10-2011-0004817

(51) Int. Cl. H02H 9/04

(52) U.S. Cl. 361/56

(57) ABSTRACT

A semiconductor module includes a printed circuit board, at least one on-board device unit coupled between at least one voltage line and a power line. The at least on-board device unit is mounted on the printed circuit board. At least one electrostatic discharge protection circuit unit, configured to protect the at least one on-board device unit from an electrostatic discharge that occurs in the at least one voltage line, is coupled to the at least one voltage line.

### CROSS-REFERENCE TO RELATED APPLICATION(S)

This application claims priority under 35 USC §119 from Korean Patent Applications No. 10-2011-0004817, filed on Jan. 18, 2011 in the Korean Intellectual Property Office (KIPO), the contents of which are incorporated herein in its entirety by reference.

### BACKGROUND

1. Technical Field

Apparatuses consistent with exemplary embodiments relate generally to electrostatic discharge (ESD) protection techniques, and more particularly, to a semiconductor module having an ESD protection circuit, and a system including the same.

2. Description of the Related Art

Generally, electrostatic charges may be generated in a semiconductor module while the semiconductor module is handled by operators. Thus, a plurality of devices included in the semiconductor module may be damaged by the electrostatic charges when an electrostatic discharge (ESD) occurs. Thus, an ESD protection circuit may be used to improve an ESD tolerance level of a semiconductor module. According to the related art, a semiconductor device mounted on a printed circuit board (PCB) of a semiconductor module may include an ESD protection circuit near an input/output (I/O) pad in order to protect the semiconductor device from ESD damages (e.g., destruction of a thin insulation layer such as a gate oxide layer). For example, a semiconductor device manufactured by packaging a silicon substrate chip may include an ESD protection circuit that uses P-N diode characteristics in order to satisfy a human body model (HBM) and a machine model (MM) for products. However, there is no standard in an ESD tolerance level for a semiconductor module having at least one semiconductor device and at least one on-board device that are mounted on a PCB. As a result, in a circumstance in which a semiconductor device having an ESD protection circuit mounted on a PCB of a semiconductor module is protected from ESD damages, an on-board device such as a decoupling capacitor mounted on the PCB of the semiconductor module may not be protected from the ESD damages.

### SUMMARY

One or more exemplary embodiments provide a semiconductor module having an electrostatic discharge (ESD) protection circuit unit for protecting at least one on-board device mounted on a printed circuit board (PCB) of the semiconductor module.

One or more exemplary embodiments provide a system including the semiconductor module.

According to an aspect of an exemplary embodiment, a semiconductor module may include a printed circuit board (PCB), at least one on-board device unit coupled between at least one voltage line and a power line. The at least on-board device unit is mounted on the PCB. At least one electrostatic discharge (ESD) protection circuit unit, configured to protect the at least one on-board device unit from an ESD that occurs in the at least one voltage line, is coupled to the at least one voltage line.

The semiconductor module may further include a semiconductor device that is mounted on the PCB.

The at least one voltage line may be electrically connected to the semiconductor device and may provide the semiconductor device with a reference voltage for operations of internal function circuits of the semiconductor device.

The at least one ESD protection circuit unit may be configured to prevent a current, generated by an ESD that occurs in the at least one voltage line, from flowing through the at least one on-board device unit.

The at least one ESD protection circuit unit may be mounted on the PCB with the semiconductor device as a single, combined component.

The semiconductor device may include at least one non-used input/output (I/O) pad coupled between the at least one ESD protection circuit unit and the at least one voltage line.

The at least one non-used I/O pad may be blocked from internal function circuits of the semiconductor device.

The at least one ESD protection circuit unit and the semiconductor device may be separately mounted on the PCB.

The at least one ESD protection circuit unit may perform an ESD protection function based on an ESD protection threshold value that is substantially the same as an ESD protection threshold value of an ESD protection circuit of the semiconductor device.

The semiconductor module may further include a first semiconductor device that is mounted on the PCB, and a second semiconductor device that is mounted on the PCB.

The at least one ESD protection circuit unit may include a first ESD protection circuit unit and a second ESD protection circuit unit.

The at least one on-board device unit may include a first on-board device unit and a second on-board device unit.

The first semiconductor device may include the first ESD protection circuit, and a first voltage line of the at least one voltage line may be coupled to the first ESD protection circuit unit.

The second semiconductor device may include the second ESD protection circuit unit, and a second voltage line of the at least one voltage line may be coupled to the second ESD protection circuit unit.

The first semiconductor device may include at least one non-used input/output (I/O) pad coupled between the first ESD protection circuit unit and the first voltage line.

The second semiconductor device may include at least one non-used I/O pad coupled between the second ESD protection circuit unit and the second voltage line.

The first ESD protection circuit unit may be configured to prevent a current, generated by an ESD that occurs in the first voltage line, form flowing through the first on-board device unit.

The second ESD protection circuit unit may be configured to prevent a current, generated by an ESD that occurs in the second voltage line, form flowing through the second on-board device unit.

According to an aspect of an exemplary embodiment, a system may include a semiconductor module, and a module controller that controls the semiconductor module. The semiconductor module may include a printed circuit board (PCB), at least one on-board device unit coupled between at least one voltage line and a power line, wherein the at least on-board device unit is mounted on the PCB, and at least one electrostatic discharge (ESD) protection circuit unit configured to protect the at least one on-board device unit from an ESD that occurs in the at least one voltage line, wherein the at least one ESD protection circuit unit is coupled to the at least one voltage line.

A semiconductor module according one or more exemplary embodiments may efficiently protect at least one on-board device mounted on a printed circuit board (PCB) from electrostatic discharge (ESD) damages.

In addition, a system according to one or more exemplary embodiments may efficiently protect at least one on-board device mounted on a printed circuit board (PCB) of the semiconductor module from electrostatic discharge (ESD) damages.

### BRIEF DESCRIPTION OF THE DRAWINGS

The above and/or other aspects will be more clearly understood from the following detailed description of exemplary embodiments taken in conjunction with the accompanying drawings in which:

FIG. 1 is a block diagram illustrating a semiconductor module according to an exemplary embodiment.

FIGS. 2 through 5 are block diagrams illustrating examples of a semiconductor module of FIG. 1.

FIG. 6 is a block diagram illustrating an electrostatic discharge (ESD) protection circuit unit in a semiconductor module of FIG. 1.

FIGS. 7A, 7B, and 7C are diagrams illustrating examples of an electrostatic discharge (ESD) protection circuit unit of FIG. 6.

FIG. 8 is a diagram illustrating an example of clamp devices of FIG. 6.

FIGS. 9 through 11 are diagrams illustrating other examples of a semiconductor module of FIG. 1.

FIG. 12 is a graph illustrating an effect of a semiconductor module of FIG. 1.

FIG. 13 is a block diagram illustrating a system according to an exemplary embodiment.

### DETAILED DESCRIPTION OF THE EMBODIMENTS

Exemplary embodiments will be described more fully hereinafter with reference to the accompanying drawings. Exemplary embodiments, however, may take The present invention may, however, be embodied in many different forms and should not be construed as limited to by the descriptions example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

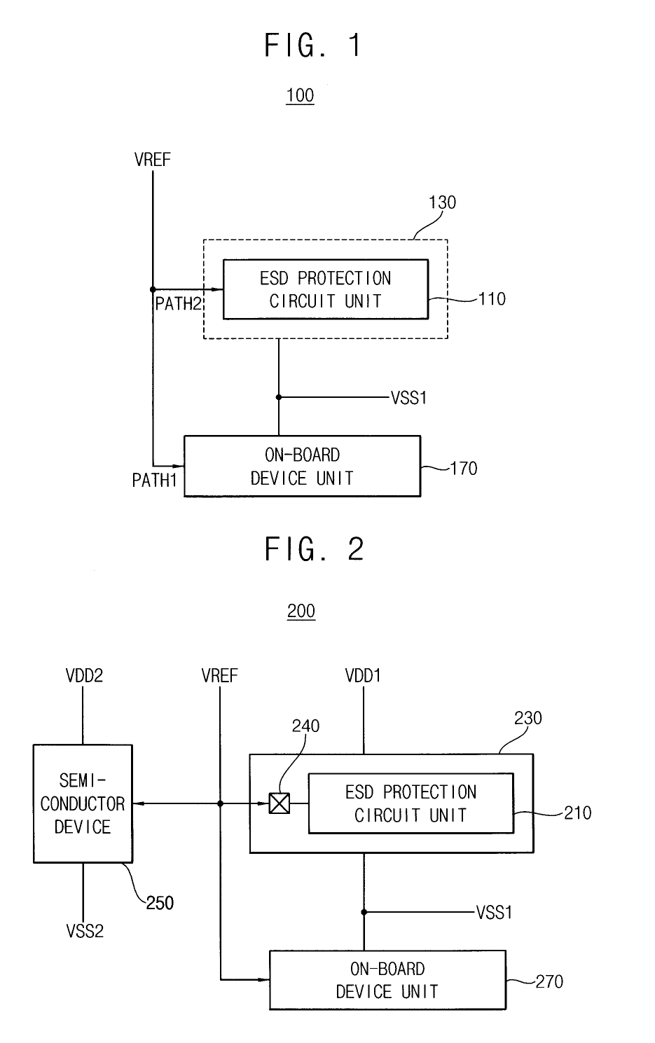

FIG. 1 is a block diagram illustrating a semiconductor module according to an exemplary embodiment.

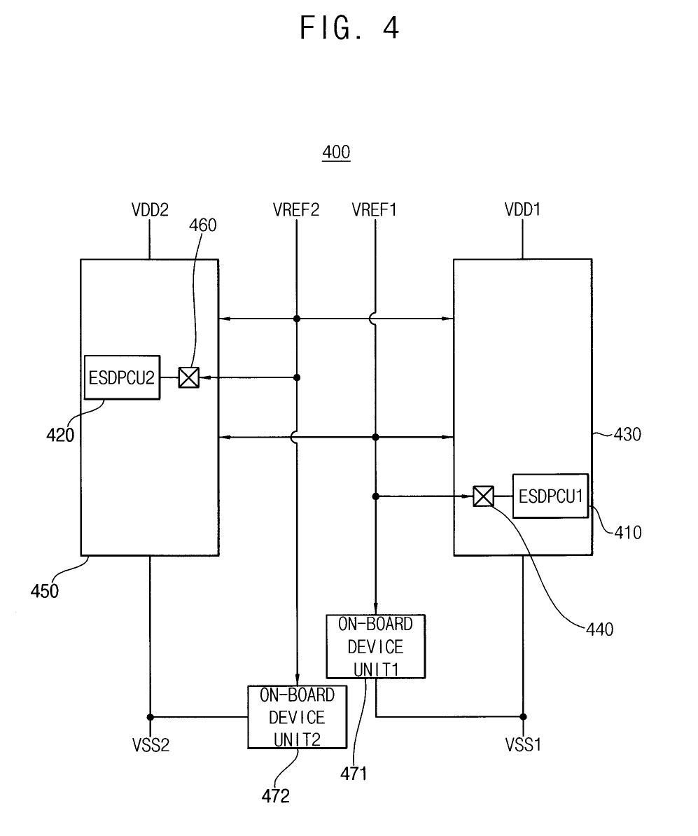

Referring to FIG. 1, the semiconductor module 100 may include a PCB (not shown), an on-board device unit 170, and an ESD protection circuit unit 110. For convenience of description, one on-board device unit 170 and one ESD protection circuit unit 110 are illustrated in FIG. 1. However, the number of on-board device units and the number of ESD protection circuit units 110 are not limited thereto. For example, the semiconductor module 100 may include a plurality of on-board device units and a plurality of ESD protection circuit units as illustrated in FIGS. 3 and 4.

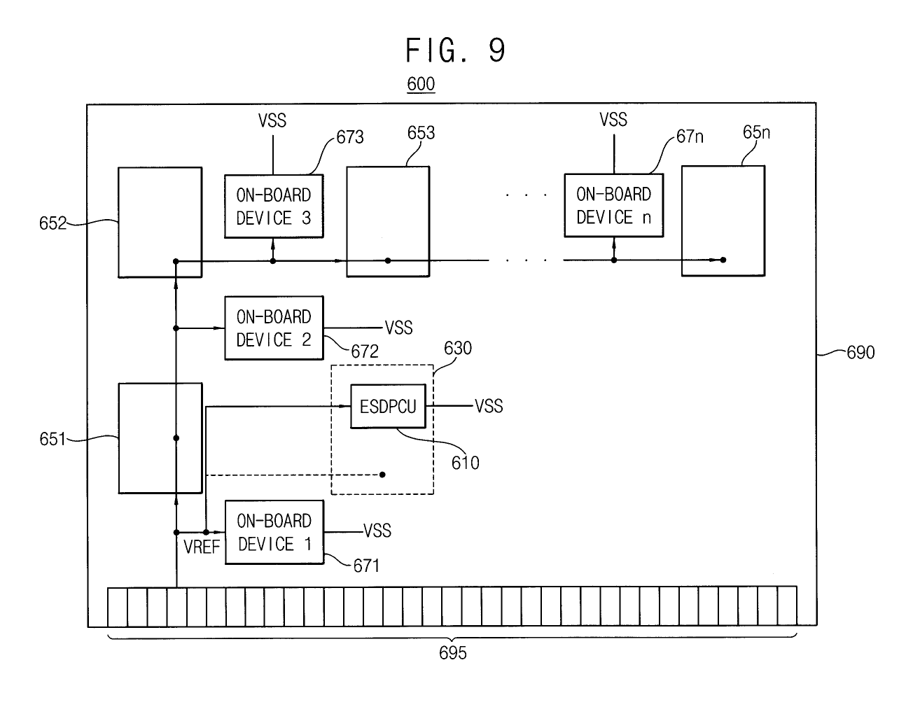

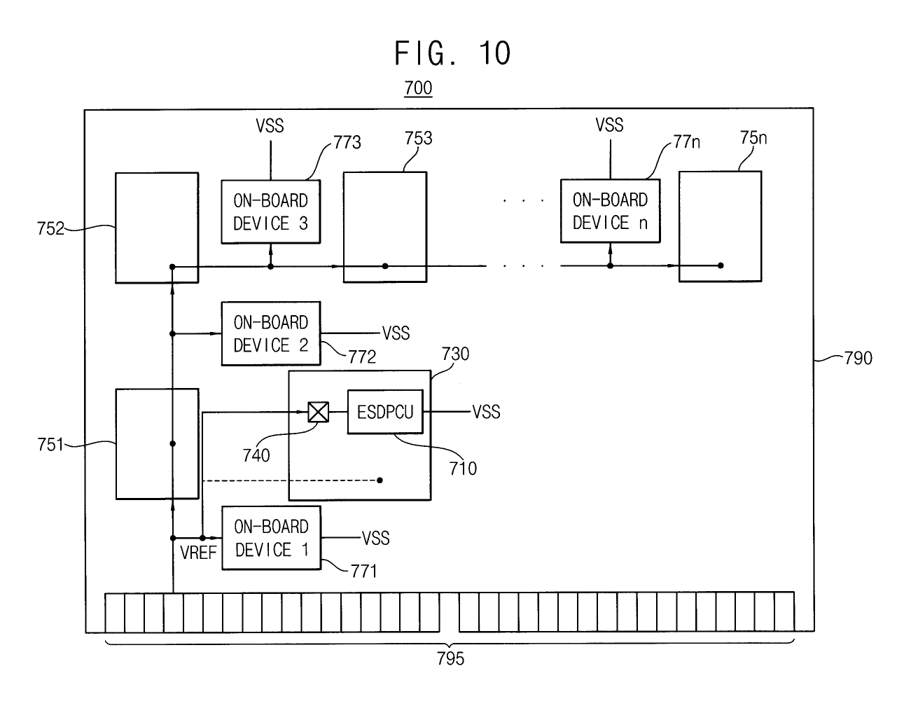

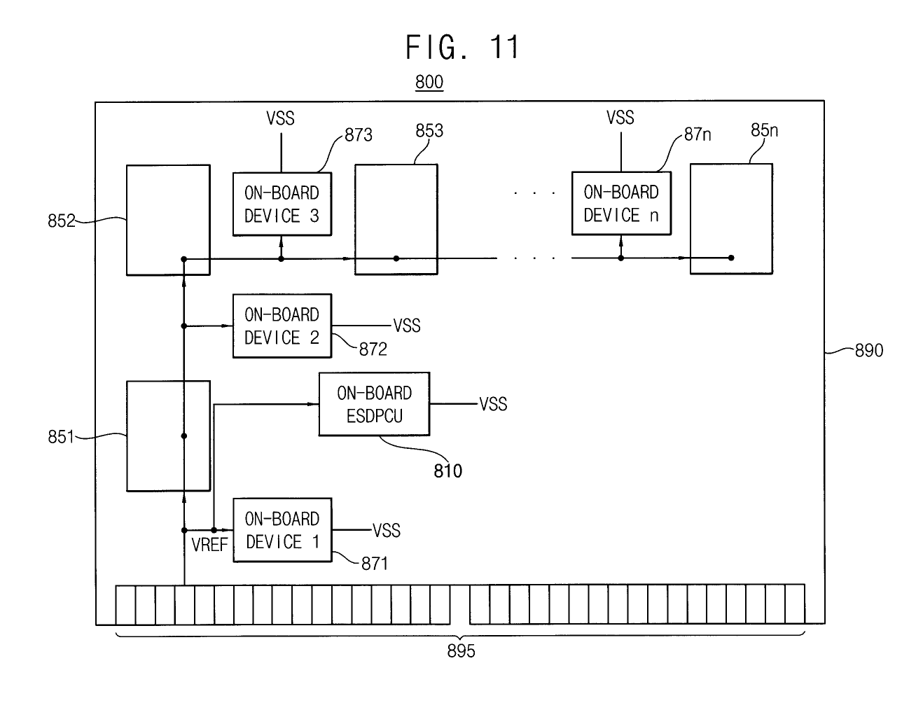

The on-board device unit 170 may be coupled between a voltage line VREF and a first power line VSS1. The on-board device unit 170 may be mounted on the PCB. For convenience of description, one voltage line VREF is illustrated in FIG. 1. However, the number of voltage lines VREF is not limited thereto. For example, there may be a plurality of voltage lines as illustrated in FIGS. 3 and 4. The voltage line VREF may include a power line (not illustrated) for providing a power to a semiconductor device 130 mounted on the semiconductor module 100. According to an exemplary aspect, the first power line VSS1 may be a ground (GND) line. The PCB will be described below with reference to FIGS. 9 through 11.

The ESD protection circuit unit 110 may be coupled to the voltage line VREF, and may protect the on-board device unit 170 from an ESD that occurs in the voltage line VREF. In detail, the ESD protection circuit unit 110 may allow current generated by an ESD that occurs in the voltage line VREF to flow through a second path PATH2 (i.e., through the ESD protection circuit unit 110) instead of a first path PATH1 (i.e., through the on-board device unit 170) toward the first power line VSS1. Hence, the current generated by the ESD that occurs in the voltage line VREF may not influence on the on-board device unit 170. Examples of an internal structure of the ESD protection circuit unit 110 will be described below with reference to FIGS. 6, 7A, 7B, 7C, and 8.

According to an exemplary aspect, the semiconductor module 100 may further include the semiconductor device 130 mounted on the PCB. The ESD protection circuit unit 110 may be included in the semiconductor device 130. In this case, the ESD protection circuit unit 110 may be mounted on the PCB as a combined component with the semiconductor device 130. Alternately, the ESD protection circuit unit 110 may not be included in the semiconductor device 130. In this case, the ESD protection circuit unit 110 may be mounted on the PCB as a separate component from the semiconductor device 130. Here, the ESD protection circuit unit 110 may perform an ESD protection function based on an ESD protection threshold value that is substantially the same as an ESD protection threshold value for the semiconductor device 130. The semiconductor module 100 may receive a reference voltage through the voltage line VREF. Furthermore, other semiconductor modules other than the semiconductor module 100 also may receive the reference voltage through the voltage line VREF.

The on-board device unit 170 may include at least one decoupling capacitor. For example, the on-board device unit 170 may include at least one capacitor coupled between the first power line VSS1 and the voltage line VREF. The at least one capacitor may prevent a phenomenon where the reference voltage of the voltage line VREF decreases as large instantaneous current flows between the voltage line VREF and the first power line VSS1 in the semiconductor device 130 mounted on the PCB.

The voltage line VREF may provide the reference voltage for operations of internal function circuits of the semiconductor device 130 mounted on the PCB. The semiconductor device 130 may be a memory device for storing data. In this case, the voltage line VREF may include a data voltage line for providing a data reference voltage, a command/address voltage line for providing a command/address reference voltage, a termination voltage line for providing a termination voltage, and/or a power line for providing a power.

A driving voltage for driving the semiconductor module 100 is progressively lowered as the semiconductor device's 130 need for a high-capacity and high-speed characteristics increases. In addition, a noise margin for stable and normal operations of the semiconductor module 100 decreases as the driving voltage for driving the semiconductor module 100 is progressively lowered. Thus, the number of decoupling capacitors coupled to the driving voltage for driving the semiconductor module 100 increases. As a result, an on-board device such as the decoupling capacitor may be defective because the on-board device such as the decoupling capacitor may be damaged by an ESD. To overcome this problem, the semiconductor module 100 may employ a protective structure in which the on-board device unit 170 mounted on the PCB is protected from the ESD. The ESD protection circuit unit 110 may be mounted on the PCB as a combined component with the semiconductor device 130. Alternately, the ESD protection circuit unit 110 may be mounted on the PCB as a separate component from the semiconductor device 130. Here, the ESD protection circuit unit 110 may perform an ESD protection function based on an ESD protection threshold value that is substantially the same as an ESD protection threshold value for the semiconductor device 130.

As described above, the semiconductor module 100 may protect the on-board device unit 170 (e.g., a plurality of on-board devices) mounted on the PCB from the ESD that occurs in the voltage line VREF by using the ESD protection circuit unit 110 mounted on the PCB. Here, the ESD protection circuit unit 110 may perform an ESD protection function based on an ESD protection threshold value that is substantially the same as an ESD protection threshold value for the semiconductor device 130.

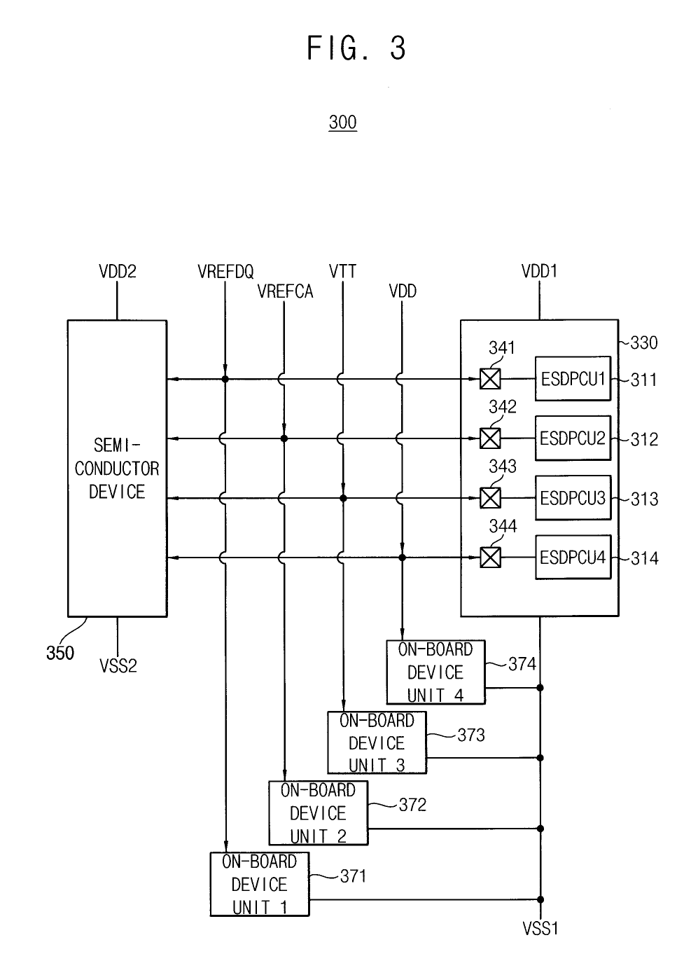

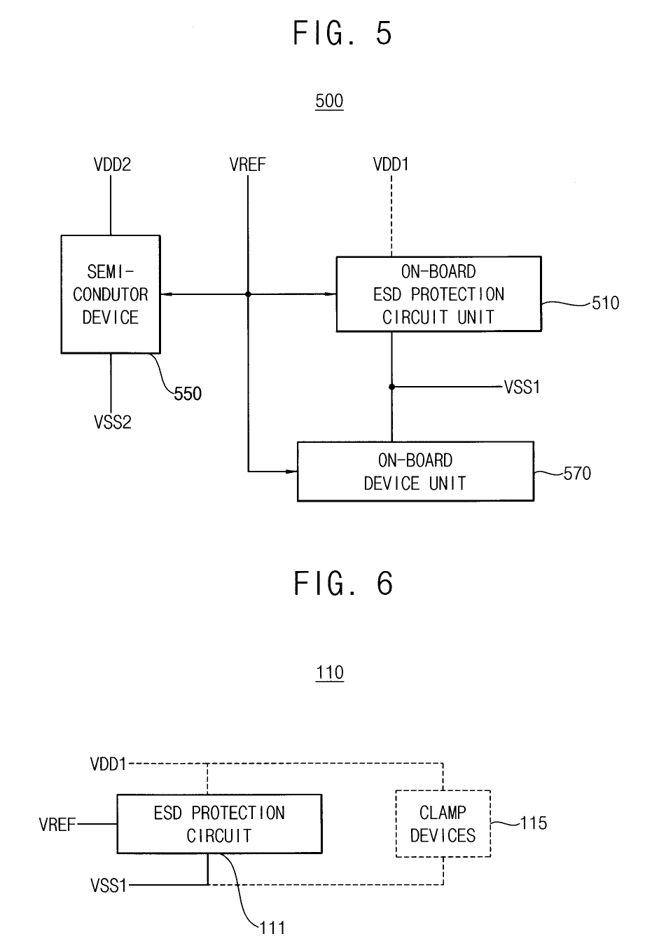

FIGS. 2 through 5 are block diagrams illustrating examples of a semiconductor module of FIG. 1. FIGS. 2 and 3 show examples of the semiconductor module of FIG. 1 where the ESD protection circuit unit 110 is mounted on the PCB as a combined component with the semiconductor device 130. FIG. 5 shows an example of the semiconductor module of FIG. 1 where the ESD protection circuit unit 110 is mounted on the PCB as a separate component from the semiconductor device 130.

Referring to FIG. 2, the semiconductor module 200 may include a PCB, a first semiconductor device 230, a second semiconductor device 250, an on-board device unit 270, and an ESD protection circuit unit 210.

The semiconductor module 200 may include the first semiconductor device 230 that has the ESD protection circuit unit 210. In this case, the ESD protection circuit unit 210 may be mounted on the PCB as a combined component with the semiconductor device 230. For convenience of description, one first semiconductor device 230 is illustrated in FIG. 2. However, the number of first semiconductor devices 230 is not limited thereto. For example, the memory module 200 may include a plurality of first semiconductor devices as illustrated in FIGS. 3 and 4.

The semiconductor device 230 may include an I/O pad 240. For convenience of description, one I/O pad 240 is illustrated in FIG. 2. However, the number of I/O pads 240 is not limited thereto. For example, the semiconductor device 230 may include a plurality of I/O pads as illustrated in FIG. 3. The I/O pad 240 may correspond to an electrical contact point formed on a substrate of the semiconductor device 230. A plurality of signals for driving the semiconductor device 230 may be transferred (i.e., input and output) through the I/O pad 240.

The I/O pad 240 may be coupled between the ESD protection circuit unit 210 and the voltage line VREF. The I/O pad 240 may receive a reference voltage through the voltage line VREF. Here, the ESD protection circuit unit 210 may be coupled between the I/O pad 240 and the first power line VSS1 to protect the I/O pad 240 from the ESD that occurs in the voltage line VREF. The ESD protection circuit unit 210 may control current generated by the ESD that occurs in the voltage line VREF to flow through the I/O pad 240 and the ESD protection circuit unit 210 from the voltage line VREF to the first power line VSS1. That is, current generated by the ESD that occurs in the voltage line VREF does not flow through the on-board device unit 270 from the voltage line VREF to the first power line VSS1. Hence, the on-board device unit 270 may be protected from the ESD by the ESD protection circuit unit 210 coupled to the I/O pad 240 of the semiconductor device 230.

The I/O pad 240 may correspond to a non-used I/O pad that is blocked from internal function circuits of the semiconductor device 230. That is, the non-used I/O pad is not used to drive the semiconductor device 230. Thus, there is no electrical coupling path between the non-used I/O pad and the internal function circuits of the semiconductor device 230 except for the first power line VSS1 and a second power line VDD1.

The semiconductor module 200 may include the second semiconductor device 250 that does not have the ESD protection circuit unit 210. For convenience of description, one second semiconductor device 250 is illustrated in FIG. 2. However, the number of second semiconductor device is not limited thereto. For example, the semiconductor module 200 may include a plurality of second semiconductor devices as illustrated in FIGS. 9, 10, and 11. The voltage line VREF may be coupled to the second semiconductor device 250 of the semiconductor module 200. Thus, a reference voltage may be applied to the second semiconductor device 250 to drive internal function circuits of the second semiconductor device 250. As described above, the reference voltage may be applied to the first semiconductor device 230 to drive internal function circuits of the first semiconductor device 230 except for the ESD protection circuit unit 210.

As illustrated in FIG. 2, the first semiconductor device 230 and the second semiconductor device 250 may receive a reference voltage through the voltage line VREF. The first semiconductor device 230 may be coupled between the first power line VSS1 and the second power line VDD1. The second semiconductor device 250 may be coupled between the third power line VSS2 and the fourth power line VDD2. That is, the first semiconductor device 230 may receive a first power through the first power line VSS1, and may receive a second power through the second power line VDD1. In addition, the second semiconductor device 250 may receive a first power through the third power line VSS2, and may receive a second power through the fourth power line VDD2. As described above, the semiconductor module 200 may include the first semiconductor device 230 having the ESD protection circuit unit 210 for the on-board device unit 270, and the second semiconductor device 250. Furthermore, the first semiconductor device 230 may further include the I/O pad 240 coupled between the voltage line VREF and the ESD protection circuit unit 210. Except for the above structure, an operation of the semiconductor module 200 of FIG. 2 may be substantially the same as an operation of the semiconductor module 100 of FIG. 1. Thus, a duplicated description will be omitted.

Referring to FIG. 3, the semiconductor module 300 may include a PCB, a plurality of on-board device units 371, 372, 373, a first semiconductor device 330, a second semiconductor device 350, and 374, and a plurality of ESD protection circuit units 311, 312, 313, and 314.

The semiconductor module 300 may include the first semiconductor device 330 having a plurality of I/O pads 341, 342, 343, and 344, and the ESD protection circuit units 311, 312, 313, and 314. The ESD protection circuit units 311, 312, 313, and 314 may be included in the first semiconductor device 330 mounted on the PCB. In this case, the ESD protection circuit units 311, 312, 313, and 314 may be mounted on the PCB as a combined component with the first semiconductor device 330.

The voltage line VREF of FIG. 1 may include a data voltage line VREFDQ, a command/address voltage line VREFCA, and a termination voltage line VTT for driving the first semiconductor device 330 and/or the second semiconductor device 350 that are mounted on the PCB. In addition, the voltage line VREF of FIG. 1 may further include a power line VDD.

The semiconductor module 300 may include the second semiconductor device 350 mounted on the PCB. The second semiconductor device 350 may not include the ESD protection circuit units 311, 312, 313, and 314, and the I/O pads 341, 342, 343, and 344. The second semiconductor device 350 mounted on the semiconductor module 300 may be coupled to the data voltage line VREFDQ, the command/address voltage line VREFCA, and the termination voltage line VTT. The second semiconductor device 350 may receive a data voltage through the data voltage line VREFDQ, may receive a command/address voltage through the command/address voltage line VREFCA, and may receive a termination voltage through the termination voltage line VTT. Likewise, the first semiconductor device 330 mounted on the semiconductor module 300 may be coupled to the data voltage line VREFDQ, the command/address voltage line VREFCA, and the termination voltage line VTT. As a result, the data voltage, the command/address voltage, and the termination voltage may be used for internal function circuits of the first semiconductor device 330 and the second semiconductor device 350 except for the ESD protection circuit units 311, 312, 313, and 314 coupled to the I/O pads 341, 342, 343, and 344. As described above, the I/O pads 341, 342, 343, and 344 may correspond to non-used I/O pads that are blocked from internal function circuits of the first semiconductor device 330. Here, the non-used I/O pads are not used to drive the first semiconductor device 330.

The power line VDD may be used for the second semiconductor device 350 instead of the fourth power line VDD2. In this case, the second semiconductor device 350 may receive a second power through the power line VDD. Alternately, the power line VDD may be used for the first semiconductor device 330 instead of the second power line VDD1. In this case, the first semiconductor device 330 may receive a second power through the power line VDD. Thus, the ESD protection circuit units 311, 312, 313, and 314 for the on-board device units 371, 372, 373, and 374 also may receive a second power through the power line VDD.

The semiconductor module 300 may include the first on-board device unit 371, the second on-board device unit 372, the third on-board device unit 373, and the fourth on-board device unit 374. The first on-board device unit 371 may be coupled between the data voltage line VREFDQ and the first power line VSS1. The second on-board device unit 372 may be coupled between the command/address voltage line VREFCA and the first power line VSS1. The third on-board device unit 373 may be coupled between the termination voltage line VTT and the first power line VSS1. The fourth on-board device unit 374 may be coupled between the power line VDD and the first power line VSS1.

The semiconductor module 300 may include the first ESD protection circuit unit 311, the second ESD protection circuit unit 312, the third ESD protection circuit unit 313, and the fourth ESD protection circuit unit 314. The first ESD protection circuit unit 311 is coupled to the data voltage line VREFDQ to protect the first on-board device unit 371 form the ESD. The second ESD protection circuit unit 312 is coupled to the command/address voltage line VREFCA to protect the second on-board device unit 372 form the ESD. The third ESD protection circuit unit 313 is coupled to the termination voltage line VTT to protect the third on-board device unit 373 form the ESD. The fourth ESD protection circuit unit 314 is coupled to the power line VDD to protect the fourth on-board device unit 374 form the ESD. Except for the above structure, an operation of the on-board device units 371, 372, 373, and 374 of FIG. 3 may be substantially the same as an operation of the on-board device unit 270 of FIG. 2. In addition, an operation of the ESD protection circuit units 311, 312, 313, and 314 of FIG. 3 may be substantially the same as an operation of the ESD protection circuit unit 210 of FIG. 2. Thus, a duplicated description will be omitted.

The I/O pads 341,342, 343, and 343 may be coupled between the ESD protection circuit units 311, 312, 313, and 314 and the voltage lines VREFDQ, VREFCA, VTT, and VDD, respectively. The ESD protection circuit units 311, 312, 313, and 314 may be coupled between the I/O pads 341, 342, 343, and 344 and the first power line VSS1, respectively. Thus, the I/O pads 341, 342, 343, and 344 may be protected from the ESD that occurs in the voltage lines VREFDQ, VREFCA, VTT, and VDD, respectively.

As described above, the semiconductor module 300 of FIG. 3 includes the I/O pads 341, 342, 343, and 344 coupled to the voltage lines VREFDQ, VREFCA, VTT, and VDD, the ESD protection circuit units 311, 312, 313, and 314 coupled to the I/O pads 341, 342, 343, and 344, and the on-board device units 371, 372, 373, and 374 coupled between the voltage lines VREFDQ, VREFCA, VTT, and VDD and the first power line VSS1. Except for the above structure, an operation of the semiconductor module 300 of FIG. 3 may be substantially the same as an operation of the semiconductor module 200 of FIG. 2. Thus, a duplicated description will be omitted.

Referring to FIG. 4, the semiconductor module 400 may include a PCB, a plurality of on-board device units 471 and 472, a first semiconductor device 430, a second semiconductor device 450, and a plurality of ESD protection circuit units 410 and 420. Here, the first semiconductor device 430 may include a first ESD protection circuit unit 410 and a first I/O pad 440. In addition, the second semiconductor device 450 may include a second ESD protection circuit unit 420 and a second I/O pad 460.

The first ESD protection circuit unit 410 may be included in the first semiconductor device 430 mounted on the PCB. The second ESD protection circuit unit 420 may be included in the second semiconductor device 450 mounted on the PCB. In this case, the first ESD protection circuit unit 410 may be mounted on the PCB as a combined component with the first semiconductor device 430, and the second ESD protection circuit unit 420 may be mounted on the PCB as a combined component with the second semiconductor device 450. That is, the semiconductor module 400 includes the first ESD protection circuit unit 410 and the second ESD protection circuit unit 420.

According to an exemplary aspect, the semiconductor module 400 may include a first voltage line VREF1 and a second voltage line VREF2. The first ESD protection circuit unit 410 may be included in the first semiconductor device 430. Here, the first ESD protection circuit unit 410 may be coupled to the first voltage line VREF1. The second ESD protection circuit unit 420 may be included in the second semiconductor device 450. Here, the second ESD protection circuit unit 420 may be coupled to the second voltage line VREF2. In detail, the first voltage line VREF1 may be coupled to the first semiconductor device 430 to provide a first reference voltage for driving the first semiconductor device 430, and the second voltage line VREF2 may be coupled to the second semiconductor device 450 to provide a second reference voltage for driving the second semiconductor device 450. Alternately, the first semiconductor device 430 may be coupled to the second voltage line VREF2 to operate based on a second reference voltage, and the second semiconductor device 450 may be coupled to the first voltage line VREF1 to operate based on a first reference voltage.

The first semiconductor device 430 may include a first non-used I/O pad 440. The second semiconductor device 450 may include a second non-used I/O pad 460. The first non-used I/O pad 440 may be coupled between the first ESD protection circuit unit 410 and the first voltage line VREF1. The second non-used I/O pad 460 may be coupled between the second ESD protection circuit unit 420 and the second voltage line VREF2. Here, the non-used I/O pads 440 and 460 may be blocked from internal function circuits of the first semiconductor device 430 and the second semiconductor device 450, respectively.

The first on-board device unit 471 may be coupled between the first voltage line VREF1 and a first power line VSS1. The second on-board device unit 472 may be coupled between the second voltage line VREF2 and the first power line VSS1. In addition, the first on-board device unit 471 may be coupled between the first ESD protection circuit unit 410 and the first power line VSS1 through the first non-used I/O pad 440, and the second on-board device unit 472 may be coupled between the second ESD protection circuit unit 420 and the first power line VSS1 through the second non-used I/O pad 460. That is, the semiconductor module 400 may protect the first on-board device unit 471 coupled to the first voltage line VREF1 and the second on-board device unit 472 coupled to the second voltage line VREF2 from the ESD by using the first ESD protection circuit unit 410 of the first semiconductor device 430 and the second ESD protection circuit unit 420 of the second semiconductor device 450, respectively.

As described above, the first ESD protection circuit unit 410 and the second ESD protection circuit unit 420 are included in different semiconductors, respectively in the semiconductor module 400. Except for the above structure, an operation of the semiconductor module 400 of FIG. 4 may be substantially the same as an operation of the semiconductor module 200 of FIG. 2. Thus, a duplicated description will be omitted.

Referring to FIG. 5, the semiconductor module 500 may include a PCB, a semiconductor device 550, an on-board device unit 570, and an ESD protection circuit unit 510. The ESD protection circuit unit 510 may be mounted on the PCB as a separate component from the semiconductor device 550 mounted on the PCB. The ESD protection circuit unit 510 may perform an ESD protection function based on an ESD protection threshold value that is substantially the same as an ESD protection threshold value of at least one ESD protection circuit in the semiconductor device 550.

The ESD protection circuit unit 510 may be separated from the semiconductor device 550. Thus, the ESD protection circuit unit 510 may be mounted on the PCB as a separate component from the semiconductor device 550. In this case, the ESD protection circuit unit 510 may perform an ESD protection function based on an ESD protection threshold value that is substantially the same as an ESD protection threshold value of at least one ESD protection circuit in the semiconductor device 550. The ESD protection circuit unit 510 may be coupled between a voltage line VREF and a first power line VSS1. Hence, an ESD current path may be formed on the ESD protection circuit unit 510. That is, the ESD current path may not be formed on the on-board device unit 570 coupled between a voltage line VREF and a first power line VSS1. As a result, the on-board device unit 570 mounted on the PCB may be protected from an ESD that occurs in the voltage line VREF. In example embodiments, the ESD protection circuit unit 510 may be coupled between the first power line VSS1 and a second power line VDD1.

Except that the ESD protection circuit unit 510 is not included in the semiconductor device 550 in the semiconductor module 500, an operation of the semiconductor module 500 of FIG. 5 may be substantially the same as an operation of the semiconductor module 100 of FIG. 1. Thus, a duplicated description will be omitted.

FIG. 6 is a block diagram illustrating an electrostatic discharge (ESD) protection circuit unit in a semiconductor module of FIG. 1.

Referring to FIG. 6, the ESD protection circuit unit 110 may include an ESD protection circuit 111. The ESD protection circuit unit 110 may be coupled between a voltage line VREF and a first power line VSS1. The ESD protection circuit unit 110 may control current generated by an ESD that occurs in the voltage line VREF to flow through the ESD protection circuit 111 toward the first power line VSS1.

According to an exemplary aspect, the ESD protection circuit unit 110 may be coupled between a second power line VDD1 and the first power line VSS1. The ESD protection circuit unit 110 may further include clamp devices 115. In this case, the ESD protection circuit unit 110 may control the current generated by the ESD that occurs in the voltage line VREF to flow through the ESD protection circuit 111 toward the first power line VSS1. Alternatively, the ESD protection circuit unit 110 may control the current generated by the ESD that occurs in the voltage line VREF to flow through the ESD protection circuit 111, the second power line VDD1, and the clamp devices 115 toward the first power line VSS1.

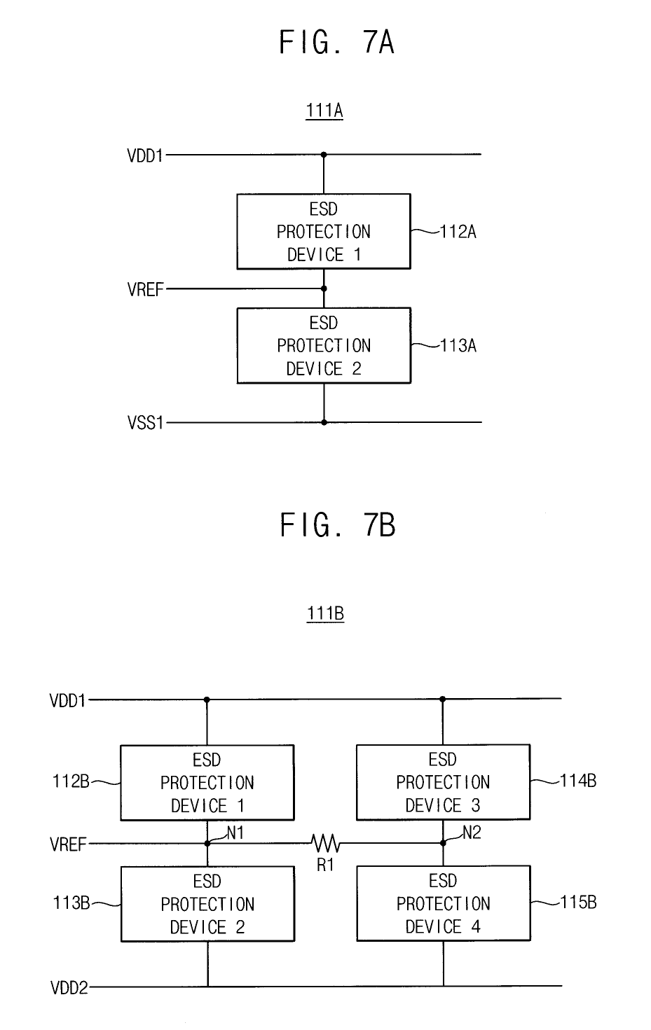

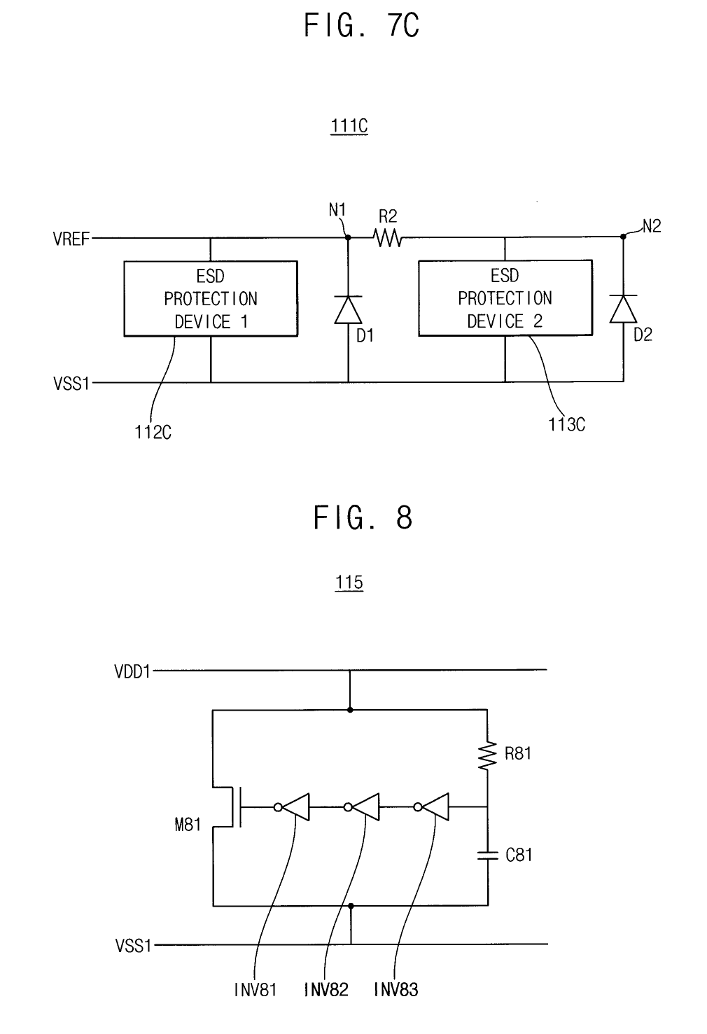

FIGS. 7A, 7B, and 7C are diagrams illustrating examples of an electrostatic discharge (ESD) protection circuit in FIG. 6.

Referring to FIG. 7A, the ESD protection circuit 111A may include a first ESD protection device 112A and a second ESD protection device 113A. The first ESD protection device 112A may be coupled between a second power line VDD1 and a voltage line VREF. The second ESD protection device 113A may be coupled between a first power line VSS1 and the voltage line VREF. The first power line VSS1 may be a GND line.

Hereinafter, it will be described how the ESD protection circuit 111A operates when an ESD occurs in the voltage line VREF. Here, it is assumed that a second voltage applied to the second power line VDD1 is higher than a first voltage applied to the first power line VSS1, and that the first power line VSS1 corresponds to the GND line. When positive charges are generated by the ESD that occurs in the voltage line VREF (i.e., a positive ESD event), the positive charges may flow through the second ESD protection device 113A toward the first power line VSS1. When negative charges are generated by the ESD that occurs in the voltage line VREF (i.e., a negative ESD event), the negative charges may flow through the first ESD protection device 112A, the second power line VDD1, and the clamp devices 115 of FIG. 6 toward the first power line VSS1. In some example embodiments, the first ESD protection device 112A and the second ESD protection device 113A may be diodes.

Referring to FIG. 7B, the ESD protection circuit 111B may include a first ESD protection circuit 112B, a second ESD protection circuit 113B, a third ESD protection circuit 114B, and a fourth ESD protection circuit 115B. In a case in which the ESD protection circuit 111B is included in the semiconductor device 130 that is mounted on the semiconductor module 100 of FIG. 1, and that the ESD protection circuit 111B is coupled to at least one I/O pad, the ESD protection circuit 111B may include a first ESD protection device pair 112B and 113B and a second ESD protection device pair 114B and 115B. The first ESD protection device pair 112B and 113B may include the first ESD protection device 112B coupled between the second power line VDD1 and a first node N1, and the second ESD protection device 113B coupled between the first power line VSS1 and the first node N1. The first node N1 may be coupled to the voltage line VREF. The second ESD protection device pair 114B and 115B may include the third ESD protection device 114B coupled between the second power line VDD1 and a second node N2, and the fourth ESD protection device 115B coupled between the first power line VSS1 and the second node N2. The ESD protection circuit 111B may further include a resistor R1 coupled between the first node N1 and the second node N2. The first through fourth ESD protection devices 112B, 113B, 114B, and 115B may be diodes.

Referring to FIG. 7C, the ESD protection circuit 111C may include a first ESD protection device 112C and a second ESD protection device 113C. The first ESD protection device 112C may be coupled between a first power line VSS1 and a first node N1 coupled to a voltage line VREF. In example embodiments, the first power line VSS1 may correspond to a GND line. When positive charges are generated by an ESD that occurs in the voltage line VREF (i.e., a positive ESD event), the positive charges may flow through the first ESD protection device 112C toward the first power line VSS1. The ESD protection circuit 111C may further include a first diode D1. The first diode D1 may be coupled between the first node N1 and the first power line VSS1. Hereinafter, it will be described how the ESD protection circuit operates when the ESD protection circuit unit 110 includes the clamp devices 115 as illustrated in FIG. 6. Here, the first power line VSS1 may correspond to the GND line. When negative charges are generated by the ESD that occurs in the voltage line VREF (i.e., a negative ESD event), the negative charges may flow through the second power line VDD1, the clamp devices 115, and the first diode Dl toward the voltage line VREF.

The second ESD protection device 113C may be coupled between the first power line VSS1 and a second node N2. The ESD protection circuit 111C may further include a second diode D2. The second diode D2 may be coupled between the second node N2 and the first power line VSS1. The ESD protection circuit 111C may further include a resistor R2 between the first node N1 and the second node N2. Each of the ESD protection devices 112C and 113C may be a gate-grounded N-type metal oxide semiconductor (ggNMOS) transistor, a gate-coupled N-type metal oxide semiconductor (gcNMOS) transistor, a substrate triggered N-type metal oxide semiconductor (stNMOS) transistor, etc.

FIG. 8 is a diagram illustrating an example of clamp devices of FIG. 6.

Referring to FIG. 8, the clamp devices 115 may include a transistor M81. The transistor M81 may provide a current path between a first power line VSS1 and a second power line VDD1 while an ESD occurs. The clamp devices 115 may further include a RC network and an inverter chain. The RC network may include a resistor R81 and a capacitor C81 that are coupled in series between a second power line VDD1 and the first power line VSS1. The inverter chain may include three inverters INV81, INV82, and INV83 that are coupled in series between a gate terminal of the transistor M81 and a node formed between the resistor R81 and the capacitor C81. The RC network and the inverter chain constitute a triggering circuit. In a normal operation mode, the triggering circuit may adjust a voltage of the gate terminal of the transistor M81 so as to control the transistor M81 to be in “off”-state. In an ESD mode, the triggering circuit may adjust a voltage of the gate terminal of the transistor M81 so as to control the transistor M81 to be in “on”-state. The transistor M81 may be an N-type metal oxide semiconductor field-effect transistor (N-MOSFET). Here, the transistor M81 has a sufficient channel width so that current generated by the ESD may flow through.

FIGS. 9 through 11 are diagrams illustrating other examples of a semiconductor module of FIG. 1. FIG. 10 shows an example of the semiconductor module where the ESD protection circuit unit 610 of FIG. 9 is mounted on the PCB as a combined component with the semiconductor device 630. FIG. 11 shows an example of the semiconductor module where the ESD protection circuit unit 610 of FIG. 9 is mounted on the PCB as a separate component from the semiconductor device 630. In FIGS. 9 through 11, arrangements and connections of semiconductor devices and on-board devices are exemplary. Thus, embodiments are not limited to illustrations of FIGS. 9 through 11.

Referring to FIG. 9, the semiconductor module 600 may include a PCB 690, an on-board device unit having a plurality of on-board devices 671 through 67n, a first semiconductor device 630, second semiconductor devices 651 through 65n, and an ESD protection circuit unit 610. For convenience of description, one on-board device unit having the on-board devices 671 through 67n, one ESD protection circuit unit 610, and one first semiconductor device 630 are illustrated in FIG. 9. However, the number of on-board device units, the number of ESD protection circuit units, and the number of first semiconductor devices are not limited thereto. For example, the semiconductor module 600 may include a plurality of on-board device units, a plurality of ESD protection circuit units, and a plurality of first semiconductor devices as illustrated in FIGS. 3 and 4.

The on-board device unit may include the on-board devices 671 through 67n. The on-board devices 671 through 67n may be coupled between a voltage line VREF and a first power line VSS. The on-board devices 671 through 67n may be mounted on the PCB 690. The voltage line VREF may include a power line for providing a power to the first semiconductor device 630 and the second semiconductor devices 651 through 65n mounted on the semiconductor module 600.

Each of the on-board devices 671 through 67n may include at least one decoupling capacitor that is coupled between the voltage line VREF and the first power line VSS. According to required conditions for systems, the decoupling capacitor may have various capacitances (e.g., 3.3 pF, 2.2 nF, 22 nF, 100 nF, 220 nF, 1 uF, 4.7 uF, 10 uF, etc).

The ESD protection circuit unit 610 may be coupled to the voltage line VREF to protect the on-board devices 671 through 67n from an ESD that occurs in the voltage line VREF. According to an exemplary aspect, as illustrated in FIG. 10, the ESD protection circuit unit 610 may be included in a semiconductor device. That is, the ESD protection circuit unit 610 may be mounted on the PCB as a combined component with the semiconductor device. Alternately, as illustrated in FIG. 11, the ESD protection circuit unit 610 may be mounted on the PCB as a separate component from semiconductor devices. In this case, the ESD protection circuit unit 610 may perform an ESD protection function based on an ESD protection threshold value that is substantially the same as an ESD protection threshold value for the semiconductor devices.

The first semiconductor device 630 and the second semiconductor devices 651 through 65n may be implemented by various packages such as Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flat-Pack (TQFP), Small Outline Integrated Circuit (SOIC), Shrink Small Outline Package (SSOP), Thin Small Outline Package (TSOP), Thin Quad Flat-Pack (TQFP), System In Package (SIP), Multi Chip Package (MCP), Wafer-level Fabricated Package (WFP), Wafer-Level Processed Stack Package (WSP).

The second semiconductor devices 651 through 65n may be coupled to the voltage line VREF to receive a reference voltage for operations of internal function circuits of the second semiconductor devices 651 through 65n mounted on the PCB through the voltage line VREF. In addition, the first semiconductor device 630 also may be coupled to the voltage line VREF to receive a reference voltage for operations of internal function circuits of the first semiconductor device 630 mounted on the PCB through the voltage line VREF. The first semiconductor device 630 and the second semiconductor devices 651 through 65n may be memory devices for storing data. In this case, the voltage line VREF may include a data voltage line VREFDQ, a command/address voltage line VREFCA, and a termination voltage line VTT for driving the first semiconductor device 630 and the second semiconductor devices 651 through 65n mounted on the PCB 690. According to one or more exemplary aspects, the voltage line VREF may further include a power line VDD. The voltage line VREF may be coupled to outside through semiconductor module tabs 695 of the PCB 690. The first semiconductor device 630 and the second semiconductor devices 651 through 65n may be semiconductor memory devices such as a dynamic random access memory (DRAM) device, a static random access memory (SRAM) device, a flash memory device, etc. The semiconductor module 600 may be a dual in-line memory module (DIMM), a single in-line memory module (SIMM), an unbuffered dual in-line memory module (UDIMM), a registered dual in-line memory module (RDIMM), a fully buffered dual in-line memory module (FBDIMM), a load reduced dual in-line memory module (LRDIMM), etc. The semiconductor memory devices may be coupled to data transfer lines, respectively. In addition, the semiconductor memory devices may be coupled to command/address transfer lines in a tree-structure.

Except that the semiconductor module 600 includes a plurality of second semiconductor devices 651 through 65n, an operation of the semiconductor module 600 of FIG. 9 may be substantially the same as an operation of the semiconductor module 100 of FIG. 1. Thus, a duplicated description will be omitted.

Referring to FIG. 10, the semiconductor module 700 may include a PCB 790, an on-board device unit having a plurality of on-board devices 771 through 77n, a first semiconductor device 730, second semiconductor devices 751 through 75n, and an ESD protection circuit unit 710.

The ESD protection circuit unit 710 may be coupled to a voltage line VREF to protect the on-board devices 771 through 77n from an ESD that occurs in the voltage line VREF. The ESD protection circuit unit 710 may be included in the first semiconductor device 730. In this case, the ESD protection circuit unit 710 may be mounted on the PCB 790 as a combined component with the first semiconductor device 730. According to one or more exemplary aspects, a substrate of the first semiconductor device 730 may correspond to a silicon substrate.

The first semiconductor device 730 may include an I/O pad 740. The I/O pad may be coupled between the ESD protection circuit unit 710 and the voltage line VREF. The ESD protection circuit unit 710 may be coupled between the I/O pad 740 and a first power line VSS to protect the on-board devices 771 through 77n from an ESD that occurs in the voltage line VREF.

The second semiconductor devices 751 through 75n may be coupled to the voltage line VREF so as to receive a reference voltage for operations of internal function circuits of the second semiconductor devices 751 through 75n. In addition, the first semiconductor device 730 also may be coupled to the voltage line VREF so as to receive a reference voltage for operations of internal function circuits of the first semiconductor device 730. The voltage line VREF may be coupled to outside through semiconductor module tabs 795 of the PCB 790.

Except that the semiconductor module 700 includes a plurality of second semiconductor devices 751 through 75n, an operation of the semiconductor module 700 of FIG. 10 may be substantially the same as an operation of the semiconductor module 200 of FIG. 2. In addition, except that the first semiconductor device 730 includes an I/O pad 740 coupled between the voltage line VREF and the ESD protection circuit unit 710, an operation of the semiconductor module 700 of FIG. 10 may be substantially the same as an operation of the semiconductor module 600 of FIG. 9. Thus, a duplicated description will be omitted.

Referring to FIG. 11, the semiconductor module 800 may include a PCB 890, an on-board device unit having a plurality of on-board devices 871 through 87n, a plurality of semiconductor devices 851 through 85n, and an ESD protection circuit unit 810.

The ESD protection circuit unit 810 may be mounted on the PCB 890 as a separate component from the semiconductor devices 851 through 85n. Here, the ESD protection circuit unit 810 may perform an ESD protection function based on an ESD protection threshold value that is substantially the same as an ESD protection threshold value for the semiconductor devices 851 through 85n.

Except that the semiconductor module 800 includes a plurality of semiconductor devices 851 through 85n, an operation of the semiconductor module 800 of FIG. 11 may be substantially the same as an operation of the semiconductor module 500 of FIG. 5. In addition, except that the ESD protection circuit unit 810 may be mounted on the PCB 890 as a separate component from the semiconductor devices 851 through 85n, an operation of the semiconductor module 800 of FIG. 11 may be substantially the same as an operation of the semiconductor module 600 of FIG. 9. Thus, a duplicated description will be omitted.

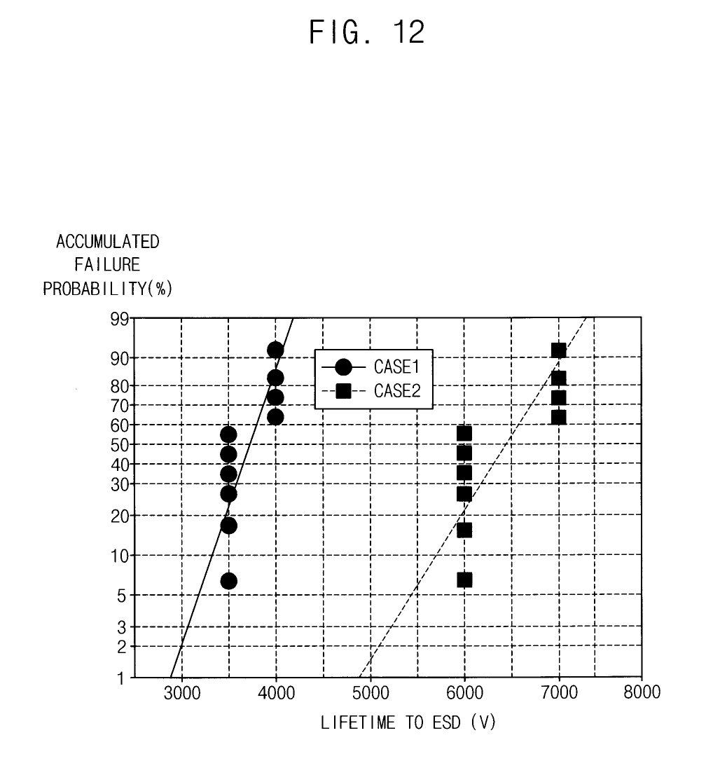

FIG. 12 is a graph illustrating an effect of a semiconductor module of FIG. 1.

Referring to FIG. 12, exemplary results, derived by applying an ESD voltage to the semiconductor module using an ESD simulator, are illustrated. A first case CASE1 indicates an accumulated failure probability of on-board devices included in related art semiconductor modules. A second case CASE2 indicates an accumulated failure probability of on-board devices included in semiconductor modules according to exemplary embodiments described herein. As illustrated in FIG. 12, an ESD protection effect for the on-board devices in the semiconductor modules according to exemplary embodiments may be improved by approximately 2500 kV compared to an ESD protection effect for the on-board devices in related art semiconductor modules.

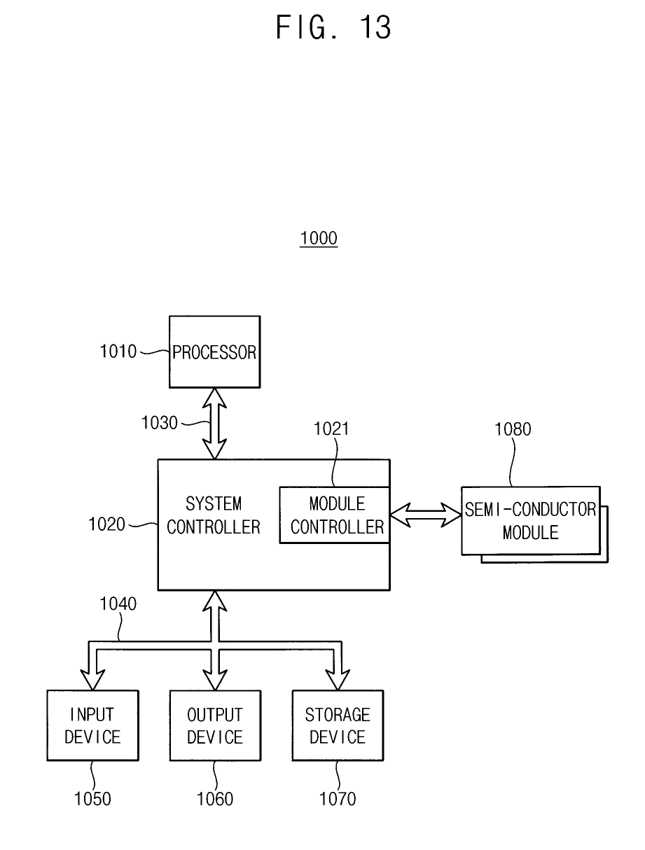

FIG. 13 is a block diagram illustrating a system according to an exemplary embodiment.

Referring to FIG. 13, the system 1000 may include a processor 1010, a system controller 1020, and a semiconductor module 1080. Here, the semiconductor module 1080 may correspond to the semiconductor module 100 of FIG. 1. The system 1000 may further include a processor bus 1030, an extended bus 1040, an input device 1050, an output device 1060, and a storage device 1070. The system controller 1020 may include a module controller 1021.

The processor 1010 may perform various computing functions. For example, the processor 1010 may be a micro processor, a central processing unit (CPU), and etc. The processor 1010 may be coupled to the system controller 1020 via a processor bus 1030 including an address bus, a control bus, and/or a data bus. Further, the system controller 1020 may be coupled to the extended bus 1040 such as a peripheral component interconnection (PCI) bus. Thus, the processor 1010 may control at least one input device 1050 (e.g., a keyboard, a mouse, etc), at least one output device 1060 (e.g., a display, a speaker, etc), and/or at least one storage device 1070 (e.g., a hard-disk drive, a solid state drive, CD-ROM, etc) via the system controller 1020.

The module controller 1021 may control the semiconductor module 1080 to perform commands that are provided by the processor 1010. The semiconductor module 1080 may include at least one dynamic random access memory (DRAM) device, at least one static random access memory (SRAM) device, and/or at least one non-volatile memory device. In this case, the semiconductor module 1080 may store data that are provided by the memory controller 1021, and provide stored data to the memory controller 1021. For example, the system 1000 may correspond to a desktop computer, a laptop computer, a workstation, a handheld device, etc.

As described above, in semiconductor modules according to one or more exemplary embodiments, at least one on-board device unit mounted on a PCB may be coupled to at least one ESD protection circuit unit. Thus, the semiconductor module and the system having the semiconductor module may protect the at least one on-board device unit based on an ESD protection threshold value (i.e., related to an ESD protection level) that is substantially the same as an ESD protection threshold value (i.e., related to an ESD protection level) for the at least one semiconductor device mounted on the PCB. As a result, the ESD protection level of the at least one on-board device unit can be efficiently improved.

The foregoing description of exemplary embodiments is not to be construed as limiting thereof. Although a few exemplary embodiments have been described, those skilled in the art will readily appreciate that many modifications are possible to the exemplary embodiments. Accordingly, all such modifications are intended to be included within the scope of the exemplary embodiments, and modifications to the described exemplary embodiments, as well as other exemplary embodiments, are intended to be included within the scope of the appended claims.

What is claimed is:

1. A semiconductor module comprising:
a printed circuit board (PCB);
at least one device unit coupled between at least one voltage line and a power line, wherein the at least device unit is mounted on the PCB; and
at least one electrostatic discharge (ESD) protection circuit unit configured to protect the at least one device unit from an ESD that occurs in the at least one voltage line, wherein the at least one ESD protection circuit unit is coupled to the at least one voltage line.

2. The module of claim 1 further comprising:
a semiconductor device that is mounted on the PCB.

3. The module of claim 2, wherein the at least one voltage line is electrically connected to the semiconductor device and provides the semiconductor device with a reference voltage for operations of internal function circuits of the semiconductor device.

4. The module of claim 2, wherein the at least one ESD protection circuit unit is configured to prevent a current, generated by an ESD that occurs in the at least one voltage line, from flowing through the at least one device unit.

5. The module of claim 2, wherein the at least one ESD protection circuit unit is mounted on the PCB with the semiconductor device as a single, combined component.

6. The module of claim 5, wherein the semiconductor device comprises at least one non-used input/output (I/O) pad coupled between the at least one ESD protection circuit unit and the at least one voltage line.

7. The module of claim 6, wherein the at least one non-used I/O pad is blocked from internal function circuits of the semiconductor device.

8. The module of claim 2, wherein the at least one ESD protection circuit unit and the semiconductor device are separately mounted on the PCB.

9. The module of claim 8, wherein the at least one ESD protection circuit unit performs an ESD protection function based on an ESD protection threshold value that is substantially the same as an ESD protection threshold value of an ESD protection circuit of the semiconductor device.

10. The module of claim 1 further comprising:
a first semiconductor device that is mounted on the PCB; and
a second semiconductor device that is mounted on the PCB.

11. The module of claim 10, wherein the at least one ESD protection circuit unit comprises a first ESD protection circuit unit and a second ESD protection circuit unit, and
wherein the at least one device unit comprises a first device unit and a second device unit.

12. The module of claim 11, wherein the first semiconductor device comprises the first ESD protection circuit unit, and a first voltage line of the at least one voltage line is coupled to the first ESD protection circuit unit, and
wherein the second semiconductor device comprises the second ESD protection circuit unit, and a second voltage line of the at least one voltage line is coupled to the second ESD protection circuit unit.

13. The module of claim 12, wherein the first semiconductor device comprises at least one non-used input/output (I/O) pad coupled between the first ESD protection circuit unit and the first voltage line, and
wherein the second semiconductor device comprises at least one non-used I/O pad coupled between the second ESD protection circuit unit and the second voltage line.

14. The module of claim 13, wherein the first ESD protection circuit unit is configured to prevent a current, generated by an ESD that occurs in the first voltage line, from flowing through the first device unit, and
wherein the second ESD protection circuit unit is configured to prevent a current, generated by an ESD that occurs in the second voltage line, from flowing through the second device unit.

15. A system comprising:
a semiconductor module; and
a module controller configured to control the semiconductor module,
wherein the semiconductor module comprises:
a printed circuit board (PCB);
at least one device unit coupled between at least one voltage line and a power line, wherein the at least one device unit is mounted on the PCB; and
at least one electrostatic discharge (ESD) protection circuit unit configured to protect the at least one device unit from an ESD that occurs in the at least one voltage line, wherein the at least one ESD protection circuit unit is coupled to the at least one voltage line.

16. A semiconductor module comprising:
a printed circuit board (PCB);
at least one voltage line and at least one power line;
at least one on-board device unit; and
at least one electrostatic discharge (ESD) protection circuit, electrically coupled between the at least one voltage line and the at least one on-board device unit;
wherein an ESD in the at least one voltage line is transmitted to the at least one ESD protection circuit and away from the at least one on-board device unit.

17. A system comprising:
the semiconductor module of claim 16; and
a module controller configured to control the semiconductor module.

18. The semiconductor module of claim 16, further comprising:
a semiconductor device comprising the at least one ESD protection circuit.

19. The semiconductor device of claim 16, wherein that at least one on-board device unit comprises a plurality of on-board device units, and the at least one ESD device comprises a plurality of ESD devices, wherein at least one of the plurality of ESD devices is electrically coupled between the at least one voltage line and each of the plurality of on board device units.
